(19) United States
(12) Patent Application Publication
(10) Pub. No.: US 2026/0244321 A1
(43) Pub. Date: Aug. 20, 2026

(54) MATERIAL DISPLAY METHOD AND APPARATUS, DEVICE, COMPUTER-READABLE STORAGE MEDIUM, AND PRODUCT

(71) Applicant: Beijing Zitiao Network Technology Co., Ltd., Beijing (CN)

(72) Inventors: Danying LIU, Beijing (CN); Liyi JIAN, Beijing (CN)

(21) Appl. No.: 18/876,590

(22) PCT Filed: Jun. 20, 2023
(86) PCT No.: PCT/CN2023/101515

§ 371 Date: Dec. 18, 2024

(30) Foreign Application Priority Data
Jun. 28, 2022 (CN) 202210754285.2

(51) Int. Cl. G06F 3/04845; G06F 3/04817; G06F 3/0482; G06T 11/60

(52) U.S. Cl. CPC G06F 3/04845; G06F 3/04817; G06F 3/0482; G06T 11/60

(57) ABSTRACT

Embodiments of the present disclosure provide a material display method and apparatus, a computer-readable storage medium, a computer program product, and a computer program. The method includes: displaying a material display page in response to an acquisition operation of a user for the material display page, in which the material display page is used for displaying at least one first material; and performing a switching operation on the at least one first material displayed on the material display page in response to a preset switching condition being satisfied, in which the preset switching condition includes one or more items selected from a group consisting of system time being matched with preset switching time, an existence of an updated first material. a material update request triggered by the user being acquired, and a preset page jump operation triggered by the user being acquired.

### CROSS-REFERENCE TO RELATED APPLICATIONS

This disclosure is a national stage application of PCT/CN2023/101515 filed on Jun. 20, 2023, which claims the priority of Chinese patent application submitted to the China Patent Office on Jun. 28, 2022, with the application number 202210754285.2 and the application name “ MATERIAL DISPLAY METHOD AND APPARATUS, DEVICE, COMPUTER-READABLE STORAGE MEDIUM, AND PRODUCT”, the disclosure of which is incorporated by reference herein in its entirety as part of the present disclosure.

### TECHNICAL FIELD

Embodiments of the present disclosure relate to the interface interaction technology, and in particular, to a material display method and apparatus, a device, a computer-readable storage medium and a product.

### BACKGROUND

With the improvement of hardware performance of terminal devices and continuous advancement of artificial intelligence technology, more and more applications (APP for short) are running on the terminal devices. For example, the applications include photo editing applications, material applications, etc. The above-mentioned application software can display materials to users for selection and use.

### SUMMARY

Embodiments of the present disclosure provide a material display method and apparatus, a device, a computer-readable storage medium, a product and a program, to solve the technical problem of relatively simple display content in existing material display methods.

In a first aspect, embodiments of the present disclosure provide a material display method which includes:
displaying a material display page in response to an acquisition operation of a user for the material display page, in which the material display page is used for displaying at least one first material; and
performing a switching operation on the at least one first material displayed on the material display page in response to a preset switching condition being satisfied.

In a second aspect, embodiments of the present disclosure provide a material display apparatus which includes:
a display module, configured to display a material display page in response to an acquisition operation of a user for the material display page, in which the material display page is configured to display at least one first material; and
a switching module, configured to perform a switching operation on the at least one first material displayed on the material display page in response to a preset switching condition being satisfied;
the preset switching condition comprises one or more items selected from a group consisting of system time being matched with preset switching time, an existence of an updated first material, a material update request triggered by the user being acquired, and a preset page jump operation triggered by the user being acquired.

In a third aspect, embodiments of the present disclosure provide an electronic device which includes: a processor and a memory;
the memory stores a computer execution instruction;
the processor executes the computer execution instruction stored in the memory, to cause the processor to execute the material display method according to the above-mentioned first aspect;
the preset switching condition comprises one or more items selected from a group consisting of system time being matched with preset switching time, an existence of an updated first material, a material update request triggered by the user being acquired, and a preset page jump operation triggered by the user being acquired.

In a forth aspect, embodiments of the present disclosure provide a computer-readable storage medium, the computer-readable storage medium stores a computer execution instruction, and upon the processor executing the computer execution instruction, the material display method according to the above-mentioned first aspect is implemented.

In a fifth aspect, embodiments of the present disclosure provide a computer program product which includes a computer program, upon the computer program being executed by a processor, the material display method according to the above-mentioned first aspect is implemented.

In a sixth aspect, embodiments of the present disclosure provide a computer program, upon the computer program being executed by a processor, the material display method according to the above-mentioned first aspect is implemented.

### BRIEF DESCRIPTION OF DRAWINGS

To describe the technical solutions in the embodiments of the present disclosure or in the prior art more clearly, the accompanying drawings required in the description of the embodiments or the prior art will be described briefly below. Apparently, the drawings in the following description are some embodiments of the present disclosure, other accompanying drawings can also be derived from these drawings by those ordinarily skilled in the art without creative efforts.

FIG. 1 is a flowchart of a material display method provided by an embodiment of the present disclosure;

FIG. 2 is a schematic diagram of an interface interaction provided by an embodiment of the present disclosure;

FIG. 3 is a flowchart of a material display method provided by another embodiment of the present disclosure;

FIG. 4 is a schematic diagram of another interface interaction provided by an embodiment of the present disclosure;

FIG. 5 is a schematic diagram of a display interface provided by an embodiment of the present disclosure;

FIG. 6 is a schematic diagram of another interface interaction provided by an embodiment of the present disclosure;

FIG. 7 is a structural schematic diagram of a material display apparatus provided by an embodiment of the present disclosure; and

FIG. 8 is a structural schematic diagram of an electronic device provided by an embodiment of the present disclosure.

### DETAILED DESCRIPTION

In order to make the purpose, technical scheme and advantages of the embodiment of the disclosure more clear, the technical schemes in the embodiments of the present disclosure are described clearly and completely with the attached drawings. Obviously, the described embodiments are a part of the embodiments of the present disclosure, but not the entire embodiment. Based on the embodiments in the present disclosure, all other embodiments obtained by ordinary technicians in this field without creative work belong to the protection scope of the present disclosure.

In order to solve the technical problem of relatively simple display content and low exposure rate of the material displayed later in existing material display methods, the present disclosure provides a material display method and apparatus, a device, a computer-readable storage medium, and a product.

It should be noted that the material display method and apparatus, the device, computer-readable storage medium, and the product provided by the present disclosure can be applied in various application scenarios for displaying a plurality of materials.

The existing material display methods generally order a plurality of materials in advance and fixedly display the plurality of materials according to a preset order. However, if the above methods are used for material display, the display effect is often relatively simple and the display content is limited. If users need to view and use the material with a later order, they need to manually search for the material, which is cumbersome and leads to a poor user experience.

In the process of solving the above technical problems, the inventor(s) found through research that in order to enrich the content displayed on the material display page, a switching condition can be pre-set. If the switching condition is satisfied, a switching operation can be performed on the material displayed on the material display page. This can increase the exposure rate of the materials, and allow users to have more intuitive understanding and use of different materials on the material display page.

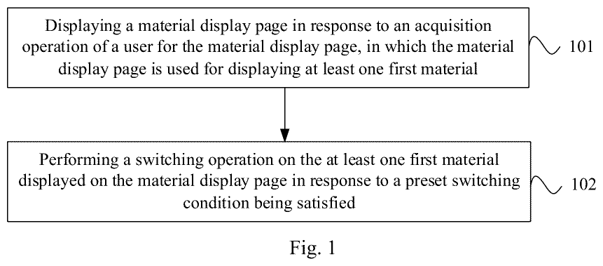

FIG. 1 is a flowchart of a material display method provided by an embodiment of the present disclosure, as shown in FIG. 1, the method includes:

Step S101: displaying a material display page in response to an acquisition operation of a user for the material display page, wherein the material display page is used for displaying at least one first material.

The execution subject of this embodiment is a material display apparatus which may be coupled to a terminal device, so as to switch and display materials based on the user's triggering operation on the terminal device. Optionally, the material display apparatus may also be coupled to a server that can communicate and be connected with the terminal device, and therefore the server can obtain the operation sent by the terminal device based on an operation input by the user through the interface interaction, and control the terminal device to perform operations of switching and displaying the materials according to the operation input by the user.

In practical application scenarios, it is often necessary to obtain and use materials. For example, the materials may specifically include filter materials, sticker materials, etc. If users perform an image editing operation, in order to obtain a better image effect, they can obtain the materials such as the filter materials, sticker materials, and the like according to actual needs for image editing. Or, the specific materials may include font materials, text frame materials, image materials, and the like. If users edit files such as presentation files and the like, they can obtain the font materials, the text frame materials, and the image materials for editing the presentation files. Or, the materials may also be any other type of materials, which is not limited in the present disclosure.

In this implementation, users can trigger the acquisition operation for the material display page according to actual needs. Correspondingly, in response to the user's acquisition operation for the material display page, the material display page can be displayed on the display interface of the terminal device, and the material display page is used to display at least one first material.

Optionally, the first material may be a conventional material, or may also be a material that requires payment for use, or the first material may be a material that requires a preset permission to be used, etc. The present disclosure does not limit the type of the material.

Step S102: performing a switching operation on the at least one first material displayed on the material display page in response to a preset switching condition being satisfied.

The preset switching condition includes one or more items selected from a group consisting of system time being matched with preset switching time, an existence of an updated first material, a material update request triggered by the user being acquired, and a preset page jump operation triggered by the user being acquired.

In this embodiment, in order to enrich the display content on the material display page, it is possible to detect whether the preset switching condition is satisfied. If the switching condition is satisfied, the switching operation can be performed on the at least one first material displayed on the material display page to display the diverse first materials on the material display page.

Optionally, the preset switching condition may be that the system time is matched with preset switching time. Correspondingly, if the system time is detected to be matched with the preset switching time, it is determined that the preset switching condition is satisfied, and the switching operation can be performed on the at least one first material displayed on the material display page.

Optionally, the preset switching condition may also be that there is an updated first material. Correspondingly, it is possible to detect the existence of the updated first material in real-time from various material acquisition channels. If an updated first material exists, it is determined that the preset switching condition is satisfied, and the switching operation can be performed on the at least one first material displayed on the material display page.

Optionally, the preset switching condition may also be that a material update request triggered by the user is acquired. Correspondingly, the triggering operation of the user on the material display page can be obtained. If the triggering operation is a material update request, it is determined that the preset switching condition is satisfied, and the switching operation can be performed on the at least one first material displayed on the material display page.

Optionally, the preset switching condition may also be that a preset page jump operation triggered by the user is acquired. Correspondingly, the page jump operation triggered by the user on the material display page can be determined in real-time. If the page jump operation is matched with any preset page jump operation, it is determined that the preset switching condition is satisfied, and the switching operation can be performed on at least one first material displayed on the material display page.

Further, based on any of the above embodiments, the step 101 includes:
displaying the material display page in response to a triggering operation of the user on a preset target application; or,
displaying the material display page in response to an image editing instruction triggered by the user in an image editing application, in which the material is used for an image editing operation.

In this embodiment, different triggering operations can be used to obtain the material display page for different application scenarios.

Optionally, if the target application is an application used to provide materials, users can trigger an icon of the target application to achieve the acquisition operation for the material display page.

Optionally, if the target application is an image editing application and an image editing instruction triggered by the user in the image editing application is obtained, the acquisition operation for the material display page can be performed according to the image editing instruction. In this image editing application, the first material is specifically used for image editing operations.

Optionally, if the target application is the image editing application, the image editing application may include various different editing operations, such as filter adjustment operation, sticker addition operation, beauty operation, size adjustment operation, etc. Therefore, the image editing instruction may also include an operation type. If the operation type is the filter adjustment operation or the sticker addition operation, the display operation of the material display page can be performed in response to the image editing instruction.

The material display page can be jumped according to different triggering operations, so that the above material display method can be applied to more application scenarios.

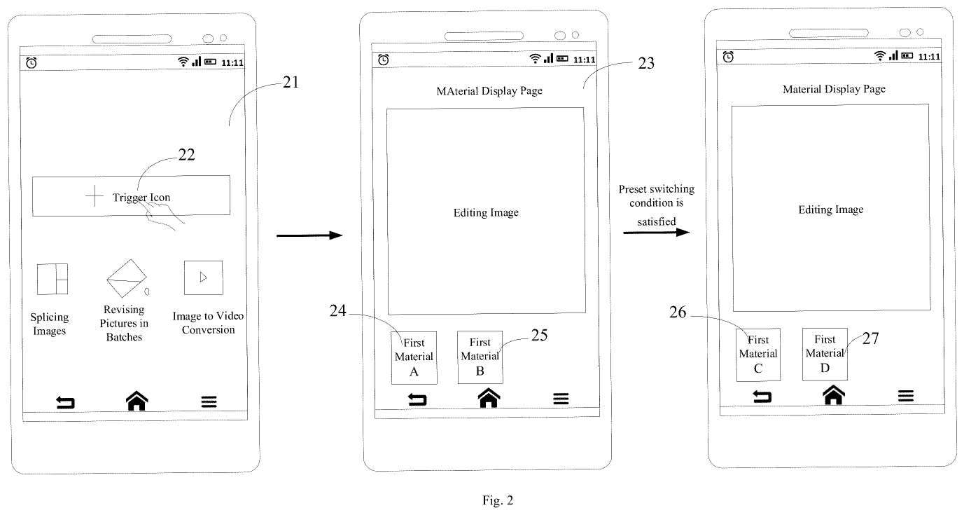

FIG. 2 is a schematic diagram of an interface interaction provided by an embodiment of the present disclosure, as shown in FIG. 2, on the homepage 21 of the image editing application, a preset trigger icon 22 can be included. Users can generate an image editing instruction by performing a triggering operation on the trigger icon 22. In response to the image editing instruction, the material display page 23 can be displayed. The first material A24 and the first material B25 are displayed on the material display page 23. If the preset switching condition is satisfied, the material displayed on the material display page 23 can be switched to the first material C26 and the first material D27.

According to the material display method provided by the embodiment, the material display page is displayed in response to the user's acquisition operation for the material display page. If it is detected that the preset switching condition is satisfied, the switching operation can be performed on the at least one first material displayed on the material display page, so that users can intuitively understand more different materials from the material display page. In addition, due to the large number of the materials and fast updates of the materials, using the above method for material display can increase the exposure rate of a plurality of materials, solve the problem that the materials displayed later are difficult for users to discover and use if the existing material display methods display materials according to a fixed order.

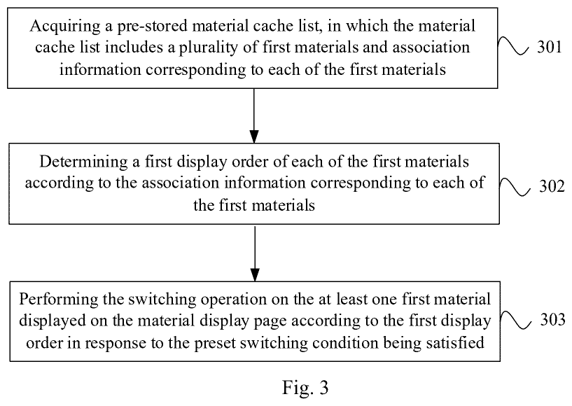

FIG. 3 is a flowchart of a material display method provided by another embodiment of the present disclosure, on the basis of any of the above embodiments, as shown in FIG. 3, the step 102 includes:
Step 301: acquiring a pre-stored material cache list, in which the material cache list includes a plurality of first materials and association information corresponding to each of the first materials.
Step 302: determining a first display order of each of the first materials according to the association information corresponding to each of the first materials.
Step 303: performing the switching operation on the at least one first material displayed on the material display page according to the first display order in response to the preset switching condition being satisfied.

In this embodiment, in order to achieve a display operation of displaying the first material in turn, the material cache list may be pre-set. The material cache list includes a plurality of first materials and association information corresponding to each of the first materials. If the first material is displayed, the first material can be obtained from the material cache list and be displayed. The associated information includes but is not limited to the performance data, creator information, type information, and the like corresponding to the first material.

It should be noted that the performance data may specifically be pre-stored backend data, instead of obtained user data.

Correspondingly, the material cache list may be obtained, and the first display order of each of the first materials may be determined based on the association information corresponding to each of the first materials in the material cache list. Further, if the preset switching condition is satisfied, the switching operation is performed on the at least one first material displayed on the material display page according to the first display order.

For example, in practical applications, if the material cache list includes eight first materials, the first display order may be determined based on the association information as follows: 1, 2; 3, 4; 5, 6; 7, 8. Therefore, the material display page may initially display materials 1 and 2. If the preset switching condition is satisfied, materials 3 and 4 can be displayed according to the first display order.

Optionally, in the process of determining the first display order of each of the first materials according to the association information corresponding to each of the first materials in the material cache list, the order of creators of the first material can be determined based on the creator information in the corresponding association information corresponding to each of the first materials. During the display operation of displaying the first material in turn, the first material created by each creator can be displayed in the order of the creators.

Optionally, in the process of determining the first display order of each of the first materials according to the association information corresponding to each of the first materials in the material cache list, the order of each preset type information can be determined according to the type information in the association information corresponding to each of the first materials. During the display operation of displaying the first material in turn, the first material corresponding to each type information can be displayed according to the order corresponding to the type information corresponding to each of the first materials.

Optionally, in the process of determining the first display order of each of the first materials according to the association information corresponding to each of the first materials in the material cache list, it is possible to determine the order by prioritizing the display of the first material with better performance based on the performance data in the association information corresponding to each of the first materials. During the display operation of displaying the first material in turn, the first materials can be displayed in sequence according to the performance data.

According to the material display method provided by this embodiment, the association information corresponding to each first material is obtained, and the first display order corresponding to the first material is determined based on the association information. Therefore, based on the first display order, the switching of the first material can be achieved if the preset switching condition is satisfied, thereby further enriching the display content of the material display page. In addition, the exposure rate of each first material in the material cache list can be increased.

Furthermore, based on any of the above embodiments, the association information includes performance data corresponding to the first material. Correspondingly, the step 302 includes:
calculating a performance score corresponding to each of the first materials according to the performance data corresponding to each of the first materials and a preset performance score calculation method; and
determining the first display order corresponding to each of the first materials based on a preset arrangement order according to the performance score.

In this embodiment, the association information may specifically include performance data corresponding to the first material. The performance data includes but is not limited to a total number of times the user has used the first material, user's evaluation on the first material, a score of the first material, and the like.

Correspondingly, after obtaining the performance data corresponding to the first material, the performance score corresponding to each first material can be calculated according to the performance data corresponding to each first material and the preset performance score calculation method. The above performance data and achieve the calculation of the performance score corresponding to the first material can be comprehensively considered by the preset performance score calculation method. It can be understood that the higher the performance score, the more popular the first material is for the user.

Therefore, after determining the performance score corresponding to each first material separately, the first display order corresponding to each first material can be determined according to the preset arrangement order. The preset arrangement order can be a descending order of performance scores, or an ascending order of performance scores corresponding to the first materials.

It can be understood that if the first display order is determined in the descending order of the performance scores corresponding to the first materials, the first material that is more in line with users' interests can be provided to the users on the material display page, to improve the users' experience.

Alternatively, if the first display order is determined in the ascending order of the performance scores corresponding to the first materials, the exposure rate of the first materials with lower performance scores can be increased on the material display page, to allow the users to understand and use the unpopular materials more.

According to the material display method provided by this embodiment, the performance score corresponding to each first material can be calculated through the preset performance score calculation method, so as to achieve orderly display operations of the first materials according to the performance scores. On the basis of implementing the display operation of displaying the first materials in turn, the display order is more in line with the actual performance data of the materials.

Further, based on any of the above embodiments, after the step 102, the method further includes:
determining a first material that has not been displayed in the material cache list in response to a total number of a time of the switching operation reaches a preset switching times threshold; and
giving a priority to displaying the first material that has not been displayed on the material display page in response to the preset switching condition being satisfied again.

In this embodiment, due to the large number of first materials, there may still be some un-displayed first materials after a preset number of the time of the switching operations for the first material. Therefore, in order to ensure the exposure of each first material, the first material that has not been displayed in the material cache list can be determined if the number of the time of the switching operations reaches the preset switching times threshold. The preset switching times threshold can be set by the user according to actual needs, for example, it can be three times, which is not limited in the present disclosure.

If it is detected that the switching condition is satisfied again, the first material that has not been displayed on the material display page can be given a priority for display.

For example, in practical applications, if the material cache list includes the first materials of No. 1-10, the material display page can initially display first materials of No. 1 and No. 2. If the preset switching condition is satisfied, the first materials of No. 3 and No. 4 can be displayed in the first display order. After three switching operations, it can be determined that the first materials of No. 7-10 are not displayed currently. Therefore, in the next switching operation, a priority can be given to displaying the first materials of No. 7-10.

According to the material display method provided by this embodiment, the exposure rate of the first material that has not been displayed in the material cache list can be improved by counting the first material that has not been displayed in the material cache list and prioritizing the display of the first material that has not been displayed in the material cache list, which ensures the exposure rate of each first material in the material cache list on the basis of enriching the display content of the material display page.

Further, based on any of the above embodiments, the step 102 includes:
performing the switching operation on the at least one first material displayed on the material display page in response to a page jump operation triggered by the user within the material display page that satisfies the preset switching condition.

In this embodiment, in order to achieve displaying of the first materials in turn, the page jump operation that satisfies the preset switching condition can be pre-set. For example, in an image editing application, the page jump operation that satisfies the preset switching condition include but is not limited to re-entering the material display page, a saving edited content operation triggered on the material display page, a completing editing operation triggered on the material display page, and a restoring operation of a last edited image, and the like.

In response to the page jump operation triggered by the user within the material display page, if the page jump operation is detected as the page jump operation that satisfies the preset switching condition, the switching operation can be performed on at least one first material displayed on the material display page.

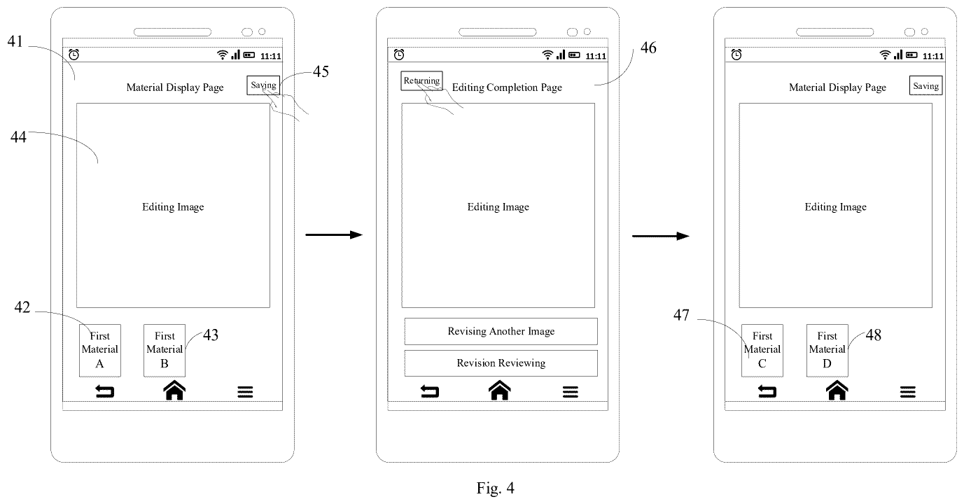

FIG. 4 is a schematic diagram of another interface interaction provided by an embodiment of the present disclosure, a material display page 41 can be displayed on the interface interaction, the first material A42 and the first material B43 can be displayed on the material display page 41. After the user completes the editing operation of the editing image 44 on the material display page 41, the editing image 44 can be saved and the material display page can be jumped to the editing completion page 46 by triggering the preset save control 45. If the user triggers a preset return control on the editing completion page 46 to jump to the material display page 41, the switching operation can be performed on the at least one first material displayed on the material display page 41, to display the first material C47 and the first material D48.

The material display method provided by this embodiment can dynamically update the first material displayed on the material display page by performing the switching operation on the first material if a page jump operation that satisfies the preset switching condition is obtained, which allows users to intuitively view and use more first materials on the material display page. In addition, the switching operation is performed on the first material based on the page jump operation that satisfies the preset switching condition, and the interactive operation is relatively simple, users can quickly view a plurality of first materials, thereby improving the user experience.

Further, based on any of the above embodiments, the preset switching condition includes a material update request triggered by the user being acquired; correspondingly, the step 102 includes:
acquiring the material update request triggered by the user through a preset operation on the material display page; and
performing the switching operation on the at least one first material displayed on the material display page according to the material update request.

In this embodiment, the preset switching condition may be that a material update request triggered by the user is acquired. Correspondingly, the material display apparatus can obtain the operation triggered by the user on the material display page in real time. If it is detected that the operation triggered by the user is matched with the preset operation, it represents that the material update request triggered by the user is acquired. The preset operation includes but is not limited to any one selected from a group consisting of up sliding operation, down sliding operation, left sliding operation and right sliding operation, or the preset operation may also be a preset pattern drawn within a preset region. Optionally, the material display page may also be provided with an update control, and users can achieve the material update request by triggering the update control.

Further, after obtaining the material update request triggered by the user, the switching operation can be performed on the first material currently displayed on the material display page based on the material update request.

According to the material display method provided by this embodiment, the currently displayed first material can be switched in response to the material update request triggered by the user, thereby enriching the display content of the material display page and improving the exposure rate of each first material in the material cache list.

Further, based on any of the above embodiments, the preset switching condition includes the existence of the updated first material; accordingly, the step 102 includes:
detecting whether a newly added first material and/or association information corresponding to the first material exist in a pre-stored material cache list in real time,
if the newly added first material and/or the association information corresponding to the first material exist, determining at least one first target material that satisfies a preset display condition according to an updated material cache list; and
performing the switching operation on the at least one first material displayed on the material display page according to the at least one first target material.

In this embodiment, at least one fixed display position may be pre-set in the material cache list, at least one first material can be fixedly displayed within the fixed display position. In order to enable the material display page to display the latest first material, it is possible to detect in real-time whether there is any newly added first material and/or association information corresponding to the first material in the pre-stored material cache list, and if yes, at least one first target material that satisfies the preset display condition can be determined according to the updated material cache list. The switching operation is performed on the at least one first material displayed on the material display page according to the at least one first target material.

According to the material display method provided by this embodiment, the switching operation can be performed on the displayed first material accordingly if the first material and/or the association information corresponding to the first material stored in the material cache list is updated, so that users can understand the updated first material in a timely manner without manually viewing the updated content, and can obtain more first materials on the material display page to meet the usage needs of the users for the first material.

Further, based on any of the above embodiments, the material display page includes at least one fixed display region and at least one display region that displays in turn, the fixed display region is used to fixedly display the first material that satisfies a preset display condition, and the display region that displays in turn is used for displaying the first material in a manner of displaying in turn.

The step 102 includes:
performing the switching operation on the first material displayed in the at least one display region that displays in turn in response to the preset switching condition being satisfied.

In this embodiment, the material display page may be provided with at least one fixed display region and at least one display region that displays in turn. The fixed display region is used to fixedly display the first material that satisfied the preset display condition, and the display region that displays in turn is used for displaying the first material in a manner of displaying in turn.

For example, in practical applications, one fixed display region may be pre-set to display the first material with the best performance data. Two display regions that displays in turns are set to display other first materials in a manner of displaying in turn.

Based on the above-mentioned page arrangements, if the preset switching condition is satisfied, the switching operation can be performed on the first material displayed in the at least one display region that displays in turn.

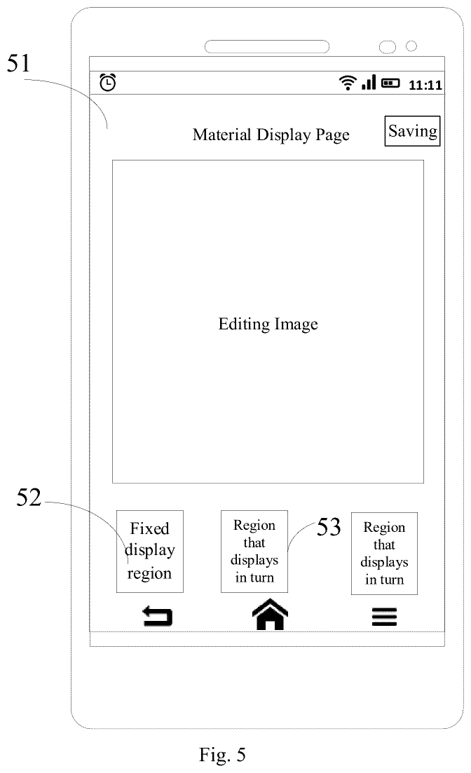

FIG. 5 is a schematic diagram of a display interface provided by an embodiment of the present disclosure, as shown in FIG. 5, the material display page 51 includes a fixed display region 52 and two display regions 53 that displays in turn. The fixed display region 52 is used for displaying the first material that satisfies the preset display condition, and the display region 53 that displays in turn is used for displaying the first material in a manner of displaying in turn.

In the material display method provided by this embodiment, by providing the fixed display region and the display region that displays in turn separately, and updating the first material displayed in the display region that displays in turn if the preset condition is satisfied, dynamic switching of the display content in the display region that displays in turn can be achieved on the basis of fixedly displaying the first material that satisfies the preset display condition, thereby enriching the display content of the material display page and enabling users to view and use more first materials more intuitively within the material display page.

Further, based on any of the above embodiments, the preset switching condition includes the existence of the updated first material, accordingly, the step 102 includes:
detecting whether a newly added first material and/or association information corresponding to the first material exist in a pre-stored material cache list in real time;
determining a first updated material that satisfies a preset display condition according to an updated material cache list, and performing the switching operation on the first material currently displayed on the display region that displays in turn according to the first updated material;
for other first materials in the updated material cache list except for the first updated material that satisfies the preset display condition, determining a second display order corresponding to the other first materials according to association information corresponding to the other first materials; and
performing a switching operation of displaying in turn on the first material displayed on the at least one display region that displays in turn according to the second display order in response to the preset switching condition being satisfied.

In this embodiment, in order to enable the material display page to display the latest first material, whether there is any newly added first material and/or association information corresponding to the first material in the pre-stored material cache list can be detected in real-time. If there is any newly added first material and/or association information corresponding to the first material in the pre-stored material cache list, the display contents in the fixed display region and the display region that displays in turn can be updated based on the updated material cache list.

Optionally, the first updated material that satisfies the preset display condition can be determined based on the updated material cache list, and the first material currently displayed in the fixed display region and the display region that displays in turn can be switched based on the first updated material. For example, the performance score of each first material in the updated material cache list can be calculated separately, and the first material with the highest performance score can be determined as the first updated material that satisfies the preset display condition, and the first updated material can be updated and displayed in the fixed display region.

Further, for other first materials in the updated material cache list except for the first updated material that satisfies the preset display condition, the second display order corresponding to the other first materials is determined based on the association information corresponding to the other first materials. For example, the second display order corresponding to the other first materials can be determined based on the performance data, and/or the creator information, and/or the type information in the association information.

Further, after determining the second display order, if the preset switching condition is satisfied, the switching operation of displaying in turn can be performed on the first material displayed on the at least one display region that displays in turn according to the second display order.

According to the material display method provided by this embodiment, the second display order can be determined according to the updated material cache list if the storing content in the material cache list is updated, and if the preset switching condition is satisfied, the switching operation of displaying in turn can be performed on the first material according to the second display order, which can enable users to understand the updated first material in a timely manner, without the need of manually viewing the updated content, and obtain more first materials on the material display page, thereby meeting the user's needs for using the first materials.

Further, based on any of the above embodiments, the preset switching condition includes the system time being matched with the preset switching time, correspondingly, the step 202 includes:
detecting whether the system time is matched with the preset switching time in real time, and
if the system time is matched with the preset switching time in real time, performing the switching operation on the at least one first material displayed on the material display page.

In this embodiment, the preset switching condition may be that the system time is matched with the preset switching time. Accordingly, in order to achieve the display operation of the first material, the system time of the terminal device with the target application installed can be determined in real time, and whether the system time is matched with the preset switching time is determined in real-time. The preset switching time can be determined based on a preset time interval. For example, the first material displayed may be switched every 2 minutes. Alternatively, the preset switching time may be a preset target time point, for example, the first material may be updated at 8 o'clock on a certain day. Accordingly, if it is detected that the system time is matched with the preset switching time, the switching operation can be performed on the at least one first material displayed on the material display page.

According to the material display method provided by this embodiment, the currently displayed first material can be switched if the system time is matched with the preset switching time, thereby enriching the display content of the material display page and improving the exposure rate of each first material in the material cache list.

Further, based on any of the above embodiments, the material display page includes a first display region and a second display region, the first display region is used for displaying the first material, the second display region is used for displaying a second material, and the first material and the second material are different types of materials.

The step 101 includes:
detecting whether the second display region includes any second material that coincides with the first material displayed in the first display region; and
if the second display region comprises any second material that coincides with the first material displayed in the first display region, deleting the any second material, in the second display region, that coincides with the first material displayed in the first display region.

In this embodiment, the material display page may include a first display region and a second display region, the first display region is used for displaying the first material, the second display region is used for displaying the second material, and the first material and the second material are different types of materials. For example, the second material may be a regular material, while the first material may be a material that requires payment for use.

Optionally, the first material and second material may be displayed under the same display category, the display category includes but is not limited to the latest material category, the hottest material category, the most frequently used category, etc.

It should be noted that based on the above page arrangement, if the material display page includes at least one fixed display region and at least one display region that displays in turn, the at least one fixed display region and the at least one display region that displays in turn may be set within the first display region.

Further, in order to optimize the display content of the material display page and avoid duplicate display of materials, it is possible to detect whether the second display region includes any second material that coincides with the first material displayed in the first display region, and if yes, the any second material displayed in the second display region that coincides with the first material displayed in the first display coincides can be deleted.

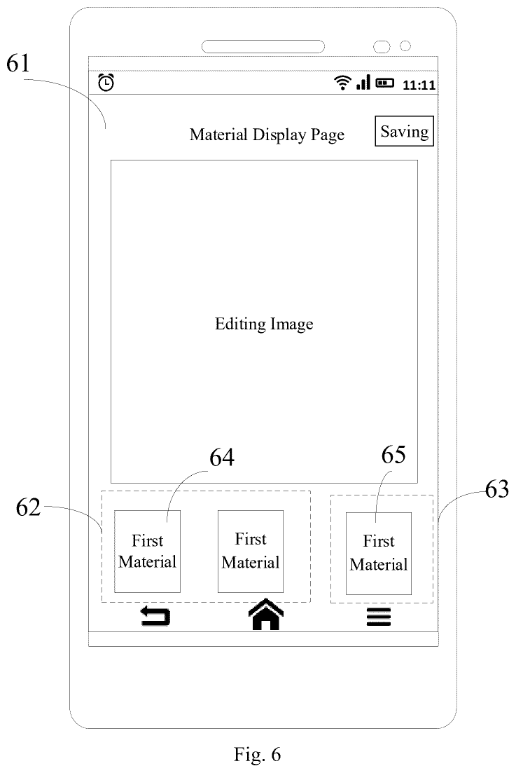

FIG. 6 is a schematic diagram of another interface interaction provided by an embodiment of the present disclosure, As shown in FIG. 6, the material display page 61 includes a first display region 62 and a second display region 63, the first display region 62 is used for displaying the first material 64, and the second display region 63 is used for displaying the second material 65.

According to the material display method provided by this embodiment, the display effect of the material display page can be optimized and the user experience can be improved by performing a duplication removing operation on the second material if the first material and the second material are displayed simultaneously on the material display page and there is any second material that coincides with the first material.

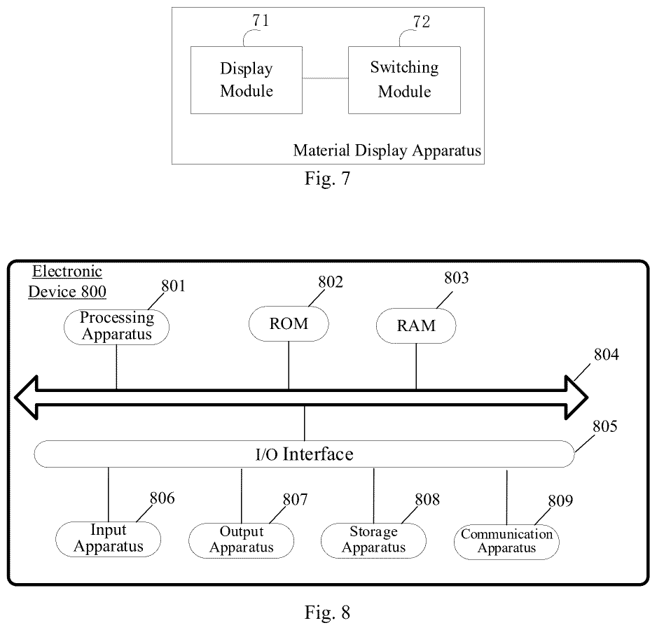

FIG. 7 is a structural schematic diagram of a material display apparatus provided by an embodiment of the present disclosure. As shown in FIG. 7, the material display apparatus includes a display module 71 and a switching module 72. The display module 71 is configured to display a material display page in response to an acquisition operation of a user for the material display page, and the material display page is configured to display at least one first material. The switching module 72 is configured to perform a switching operation on the at least one first material displayed on the material display page in response to a preset switching condition being satisfied; the preset switching condition comprises one or more items selected from a group consisting of system time being matched with preset switching time, an existence of an updated first material, a material update request triggered by the user being acquired, and a preset page jump operation triggered by the user being acquired.

Further, based on any of the above embodiments, the display module is configured to display the material display page in response to a triggering operation of the user on a preset target application, or display the material display page in response to an image editing instruction triggered by the user in an image editing application; the material is used for an image editing operation.

Further, based on any of the above embodiments, the switching module is configured to acquire a pre-stored material cache list, wherein the material cache list comprises a plurality of first materials and association information corresponding to each of the first materials, determine a first display order of each of the first materials according to the association information corresponding to each of the first materials, and perform the switching operation on the at least one first material displayed on the material display page according to the first display order in response to the preset switching condition being satisfied.

Further, based on any of the above embodiments, the association information comprises performance data corresponding to the first material; the switching module is configured to calculate a performance score corresponding to each of the first materials according to the performance data corresponding to each of the first materials and a preset performance score calculation method, and determine the first display order corresponding to each of the first materials based on a preset arrangement order according to the performance score.

Further, based on any of the above embodiments, the material display apparatus further includes: a determination module configured to determine a first material that has not been displayed in the material cache list in response to a total number of a time of the switching operation reaches a preset switching times threshold, and a processor module configured to give a priority to displaying the first material that has not been displayed on the material display page in response to the preset switching condition being satisfied again.

Further, based on any of the above embodiments, the preset switching condition comprises the material update request triggered by the user being acquired; the switching module is configured to acquire the material update request triggered by the user through a preset operation on the material display page, and perform the switching operation on the at least one first material displayed on the material display page according to the material update request.

Further, based on any of the above embodiments, the preset switching condition comprises the existence of the updated first material; the switching module is configured to perform the switching operation on the at least one first material displayed on the material display page in response to a page jump operation triggered by the user within the material display page that satisfies the preset switching condition.

Further, based on any of the above embodiments, the switching module is configured to detect whether a newly added first material and/or association information corresponding to the first material exist in a pre-stored material cache list in real time, if the newly added first material and/or the association information corresponding to the first material exist, determine at least one first target material that satisfies a preset display condition according to an updated material cache list, and perform the switching operation on the at least one first material displayed on the material display page according to the at least one first target material.

Further, based on any of the above embodiments, the material display page comprises at least one fixed display region and at least one display region that displays in turn, the fixed display region is used to fixedly display the first material that satisfies a preset display condition, and the display region that displays in turn is used to display the first material in a manner of displaying in turn. The switching module is configured to perform the switching operation on the first material displayed in the at least one display region that displays in turn in response to the preset switching condition being satisfied.

Further, based on any of the above embodiments, the preset switching condition comprises the existence of the updated first material; the switching module is configured to detect whether a newly added first material and/or association information corresponding to the first material exist in a pre-stored material cache list in real time, determine a first updated material that satisfies a preset display condition according to an updated material cache list, and perform the switching operation on the first material currently displayed on the display region that displays in turn according to the first updated material, for other first materials in the updated material cache list except for the first updated material that satisfies the preset display condition, determine a second display order corresponding to the other first materials according to association information corresponding to the other first materials, and perform a switching operation of displaying in turn on the first material displayed on the at least one display region that displays in turn according to the second display order in response to the preset switching condition being satisfied.

Further, based on any of the above embodiments, the material display page comprises a first display region and a second display region, the first display region is used for displaying the first material, the second display region is used for displaying a second material, and the first material and the second material are different types of materials. The display module is configured to detect whether the second display region comprises a second material that coincides with the first material displayed in the first display region, and if the second display region comprises any second material that coincides with the first material displayed in the first display region, delete the any second material in the second display region that coincides with the first material displayed in the first display region.

Further, based on any of the above embodiments, the preset switching condition comprises the system time being matched with the preset switching time; the switching module is configured to detect whether the system time is matched with the preset switching time in real time, and if the system time is matched with the preset switching time in real time, perform the switching operation on the at least one first material displayed on the material display page.

The material display apparatus provided in the apparatus embodiments can be used to implement the technical scheme of the above method embodiments, and the implementation principle and technical effect of the material display apparatus and the method are similar, so the details of the apparatus embodiments are not repeated here.

In order to realize the above embodiments, embodiments of the present disclosure also provide an electronic device which includes a processor and a memory.

The memory stores a computer execution instruction.

The processor executes the computer execution instruction stored in the memory, to cause the processor to execute any one of the material display methods according to the embodiments above.

FIG. 8 is a structural schematic diagram of an electronic device provided by an embodiment of the present disclosure, as shown in FIG. 8, the electronic device 800 may be a terminal device or a server. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 8 is merely an example, and should not pose any limitation to the functions and the range of use of the embodiments of the present disclosure.

As illustrated in FIG. 8, the electronic device 800 may include a processing apparatus 801 (e.g., a central processing unit, a graphics processing unit, etc.), which can perform various suitable actions and processing according to a program stored in a read-only memory (ROM) 802 or a program loaded from a storage apparatus 808 into a random-access memory (RAM) 803. The RAM 803 further stores various programs and data required for operations of the electronic device 800. The processing apparatus 801, the ROM 802, and the RAM 803 are interconnected by means of a bus 804. An input/output (I/O) interface 805 is also connected to the bus 804.

Usually, the following apparatus may be connected to the I/O interface 805: an input apparatus 806 including, for example, a touch screen, a touch pad, a keyboard, a mouse, a camera, a microphone, an accelerometer, a gyroscope, or the like; an output apparatus 807 including, for example, a liquid crystal display (LCD), a loudspeaker, a vibrator, or the like; a storage apparatus 808 including, for example, a magnetic tape, a hard disk, or the like; and a communication apparatus 809. The communication apparatus 809 may allow the electronic device 800 to be in wireless or wired communication with other devices to exchange data. While FIG. 8 illustrates the electronic device 800 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 809 and installed, or may be installed from the storage apparatus 808, or may be installed from the ROM 802. Upon the computer program being executed by the processing apparatus 801, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

Embodiments of the present disclosure further provide a computer-readable storage medium, the computer-readable storage medium stores a computer execution instruction, and upon the processor executing the computer execution instruction, any one of the material display methods according to the embodiments above is implemented.

Embodiments of the present disclosure further provide a computer program product which includes a computer program, upon the computer program being executed by a processor, any one of the material display methods according to the embodiments above is implemented.

The above-mentioned computer-readable medium may be included in the above-mentioned electronic device, or may also exist alone without being assembled into the electronic device.

The above-mentioned computer-readable medium carries one or more programs, and upon the one or more programs being executed by the electronic device, the electronic device is caused to execute any one of the material display methods according to the embodiments above.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances, for example, the first acquisition unit may also be described as “a unit that acquires at least two Internet protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

In a first aspect, embodiments of the present disclosure provide a material display method which includes:
displaying a material display page in response to an acquisition operation of a user for the material display page, in which the material display page is used for displaying at least one first material; and
performing a switching operation on the at least one first material displayed on the material display page in response to a preset switching condition being satisfied;
the preset switching condition comprises one or more items selected from a group consisting of system time being matched with preset switching time, an existence of an updated first material, a material update request triggered by the user being acquired, and a preset page jump operation triggered by the user being acquired.

According to one or more embodiments of the present disclosure,
in response to the preset switching condition being satisfied, performing the switching operation on at least one first material displayed on the material display page comprises:
acquiring a pre-stored material cache list, wherein the material cache list comprises a plurality of first materials and association information corresponding to each of the first materials;
determining a first display order of each of the first materials according to the association information corresponding to each of the first materials; and
performing the switching operation on the at least one first material displayed on the material display page according to the first display order in response to the preset switching condition being satisfied.

According to one or more embodiments of the present disclosure, the association information comprises performance data corresponding to the first material;
determining the first display order of each of the first materials according to the association information corresponding to each of the first materials comprises:
calculating a performance score corresponding to each of the first materials according to the performance data corresponding to each of the first materials and a preset performance score calculation method; and
determining the first display order corresponding to each of the first materials based on a preset arrangement order according to the performance score.

According to one or more embodiments of the present disclosure, in response to the preset switching condition being satisfied, after performing the switching operation on the at least one first material displayed on the material display page according to the first display order, the method further comprises:
determining a first material that has not been displayed in the material cache list in response to a total number of a time of the switching operation reaches a preset switching times threshold; and
giving a priority to displaying the first material that has not been displayed on the material display page in response to the preset switching condition being satisfied again.

According to one or more embodiments of the present disclosure, the preset switching condition comprises the material update request triggered by the user being acquired;
performing the switching operation on the at least one first material displayed on the material display page in response to the preset switching condition being satisfied comprises:
acquiring the material update request triggered by the user through a preset operation on the material display page; and
performing the switching operation on the at least one first material displayed on the material display page according to the material update request.

According to one or more embodiments of the present disclosure, the preset switching condition comprises the existence of the updated first material; performing the switching operation on the at least one first material displayed on the material display page in response to the preset switching condition being satisfied comprises:
performing the switching operation on the at least one first material displayed on the material display page in response to a page jump operation triggered by the user within the material display page that satisfies the preset switching condition.

According to one or more embodiments of the present disclosure, performing the switching operation on the at least one first material displayed on the material display page in response to the preset switching condition being satisfied comprises:
detecting whether a newly added first material and/or association information corresponding to the first material exist in a pre-stored material cache list in real time,
if the newly added first material and/or the association information corresponding to the first material exist, determining at least one first target material that satisfies a preset display condition according to an updated material cache list; and
performing the switching operation on the at least one first material displayed on the material display page according to the at least one first target material.

According to one or more embodiments of the present disclosure, the material display page comprises at least one fixed display region and at least one display region that displays in turn, the fixed display region is used to fixedly display the first material that satisfies a preset display condition, and the display region that displays in turn is used to display the first material in a manner of displaying in turn;
performing the switching operation on the at least one first material displayed on the material display page in response to the preset switching condition being satisfied comprises:
performing the switching operation on the first material displayed in the at least one display region that displays in turn in response to the preset switching condition being satisfied.

According to one or more embodiments of the present disclosure, the preset switching condition comprises the existence of the updated first material; performing the switching operation on the at least one first material displayed on the material display page in response to the preset switching condition being satisfied comprises:
detecting whether a newly added first material and/or association information corresponding to the first material exist in a pre-stored material cache list in real time;
determining a first updated material that satisfies a preset display condition according to an updated material cache list, and performing the switching operation on the first material currently displayed on the display region that displays in turn according to the first updated material;
for other first materials in the updated material cache list except for the first updated material that satisfies the preset display condition, determining a second display order corresponding to the other first materials according to association information corresponding to the other first materials; and
performing a switching operation of displaying in turn on the first material displayed on the at least one display region that displays in turn according to the second display order in response to the preset switching condition being satisfied.

According to one or more embodiments of the present disclosure, the material display page comprises a first display region and a second display region, the first display region is used for displaying the first material, the second display region is used for displaying a second material, and the first material and the second material are different types of materials;
displaying the material display page in response to the acquisition operation of a user for the material display page comprises:
detecting whether the second display region comprises a second material that coincides with the first material displayed in the first display region, and
if the second display region comprises a second material that coincides with the first material displayed in the first display region, deleting the second material in the second display region that coincides with the first material displayed in the first display region.

According to one or more embodiments of the present disclosure, the preset switching condition comprises the system time being matched with the preset switching time;
performing the switching operation on the at least one first material displayed on the material display page in response to the preset switching condition being satisfied comprises:
detecting whether the system time is matched with the preset switching time in real time, and
if the system time is matched with the preset switching time in real time, performing the switching operation on the at least one first material displayed on the material display page.

According to one or more embodiments of the present disclosure, displaying the material display page in response to the acquisition operation of a user for the material display page comprises:
displaying the material display page in response to a triggering operation of the user on a preset target application; or,
displaying the material display page in response to an image editing instruction triggered by the user in an image editing application, wherein the material is used for an image editing operation.

In a second aspect, embodiments of the present disclosure provide a material display apparatus which includes:
a display module, configured to display a material display page in response to an acquisition operation of a user for the material display page, in which the material display page is configured to display at least one first material; and
a switching module, configured to perform a switching operation on the at least one first material displayed on the material display page in response to a preset switching condition being satisfied;
the preset switching condition comprises one or more items selected from a group consisting of system time being matched with preset switching time, an existence of an updated first material, a material update request triggered by the user being acquired, and a preset page jump operation triggered by the user being acquired.

According to one or more embodiments of the present disclosure, the switching module is configured to:
acquire a pre-stored material cache list, wherein the material cache list comprises a plurality of first materials and association information corresponding to each of the first materials,
determine a first display order of each of the first materials according to the association information corresponding to each of the first materials, and
perform the switching operation on the at least one first material displayed on the material display page according to the first display order in response to the preset switching condition being satisfied.

According to one or more embodiments of the present disclosure, the association information comprises performance data corresponding to the first material;
the switching module is configured to:
calculate a performance score corresponding to each of the first materials according to the performance data corresponding to each of the first materials and a preset performance score calculation method, and
determine the first display order corresponding to each of the first materials based on a preset arrangement order according to the performance score.

According to one or more embodiments of the present disclosure, the material display apparatus further includes:
a determination module, configured to determine a first material that has not been displayed in the material cache list in response to a total number of a time of the switching operation reaches a preset switching times threshold, and
a processor module, configured to give a priority to displaying the first material that has not been displayed on the material display page in response to the preset switching condition being satisfied again.

According to one or more embodiments of the present disclosure, the preset switching condition comprises the material update request triggered by the user being acquired; the switching module is configured to:
acquire the material update request triggered by the user through a preset operation on the material display page, and
perform the switching operation on the at least one first material displayed on the material display page according to the material update request.

According to one or more embodiments of the present disclosure, the preset switching condition comprises the existence of the updated first material; the switching module is configured to:
perform the switching operation on the at least one first material displayed on the material display page in response to a page jump operation triggered by the user within the material display page that satisfies the preset switching condition.

According to one or more embodiments of the present disclosure, the switching module is configured to:
detect whether a newly added first material and/or association information corresponding to the first material exist in a pre-stored material cache list in real time,
if the newly added first material and/or the association information corresponding to the first material exist, determine at least one first target material that satisfies a preset display condition according to an updated material cache list, and
perform the switching operation on the at least one first material displayed on the material display page according to the at least one first target material.

According to one or more embodiments of the present disclosure, the material display page comprises at least one fixed display region and at least one display region that displays in turn, the fixed display region is used to fixedly display the first material that satisfies a preset display condition, and the display region that displays in turn is used to display the first material in a manner of displaying in turn;
the switching module is configured to:
perform the switching operation on the first material displayed in the at least one display region that displays in turn in response to the preset switching condition being satisfied.

According to one or more embodiments of the present disclosure, the preset switching condition comprises the existence of the updated first material; the switching module is configured to:
detect whether a newly added first material and/or association information corresponding to the first material exist in a pre-stored material cache list in real time,
determine a first updated material that satisfies a preset display condition according to an updated material cache list, and perform the switching operation on the first material currently displayed on the display region that displays in turn according to the first updated material,
for other first materials in the updated material cache list except for the first updated material that satisfies the preset display condition, determine a second display order corresponding to the other first materials according to association information corresponding to the other first materials, and
perform a switching operation of displaying in turn on the first material displayed on the at least one display region that displays in turn according to the second display order in response to the preset switching condition being satisfied.

According to one or more embodiments of the present disclosure, the material display page comprises a first display region and a second display region, the first display region is used for displaying the first material, the second display region is used for displaying a second material, and the first material and the second material are different types of materials;
the display module is configured to:
detect whether the second display region comprises a second material that coincides with the first material displayed in the first display region, and
if the second display region comprises any second material that coincides with the first material displayed in the first display region, delete the any second material in the second display region that coincides with the first material displayed in the first display region.

According to one or more embodiments of the present disclosure, the preset switching condition comprises the system time being matched with the preset switching time;
the switching module is configured to:
detect whether the system time is matched with the preset switching time in real time, and if the system time is matched with the preset switching time in real time, perform the switching operation on the at least one first material displayed on the material display page.

According to one or more embodiments of the present disclosure, the display module is configured to
display the material display page in response to a triggering operation of the user on a preset target application; or,
display the material display page in response to an image editing instruction triggered by the user in an image editing application, wherein the material is used for an image editing operation.

In a third aspect, embodiments of the present disclosure provide an electronic device which includes: a processor and a memory;
the memory stores a computer execution instruction;
the processor executes the computer execution instruction stored in the memory, to cause the processor to execute the material display method according to the above-mentioned first aspect and various possible designs according to the first aspect.

In a forth aspect, embodiments of the present disclosure provide a computer-readable storage medium, the computer-readable storage medium stores a computer execution instruction, and upon the processor executing the computer execution instruction, the material display method according to the above-mentioned first aspect and various possible designs according to the first aspect is implemented.

In a fifth aspect, embodiments of the present disclosure provide a computer program product which includes a computer program, upon the computer program being executed by a processor, the material display method according to the above-mentioned first aspect and various possible designs according to the first aspect is implemented.

In a sixth aspect, embodiments of the present disclosure provide a computer program, upon the computer program being executed by a processor, the material display method according to the above-mentioned first aspect and various possible designs according to the first aspect is implemented.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A material display method, wherein the method comprises:
displaying a material display page in response to an acquisition operation of a user for the material display page, wherein the material display page is used for displaying at least one first material; and
performing a switching operation on the at least one first material displayed on the material display page in response to a preset switching condition being satisfied,
wherein the preset switching condition comprises one or more items selected from a group consisting of system time being matched with preset switching time, an existence of an updated first material, a material update request triggered by the user being acquired, and a preset page jump operation triggered by the user being acquired.

2. The method according to claim 1, wherein in response to the preset switching condition being satisfied, performing the switching operation on at least one first material displayed on the material display page comprises:
acquiring a pre-stored material cache list, wherein the material cache list comprises a plurality of first materials and association information corresponding to each of the first materials;
determining a first display order of each of the first materials according to the association information corresponding to each of the first materials; and
performing the switching operation on the at least one first material displayed on the material display page according to the first display order in response to the preset switching condition being satisfied.

3. The method according to claim 2, wherein the association information comprises performance data corresponding to the first material;
determining the first display order of each of the first materials according to the association information corresponding to each of the first materials comprises:
calculating a performance score corresponding to each of the first materials according to the performance data corresponding to each of the first materials and a preset performance score calculation method; and
determining the first display order corresponding to each of the first materials based on a preset arrangement order according to the performance score.

4. The method according to claim 1, wherein in response to the preset switching condition being satisfied, after performing the switching operation on the at least one first material displayed on the material display page according to the first display order, the method further comprises:
determining a first material that has not been displayed in the material cache list in response to a total number of a time of the switching operation reaches a preset switching times threshold; and
giving a priority to displaying the first material that has not been displayed on the material display page in response to the preset switching condition being satisfied again.

5. The method according to claim 1, wherein the preset switching condition comprises the material update request triggered by the user being acquired;
performing the switching operation on the at least one first material displayed on the material display page in response to the preset switching condition being satisfied comprises:
acquiring the material update request triggered by the user through a preset operation on the material display page; and
performing the switching operation on the at least one first material displayed on the material display page according to the material update request.

6. The method according to claim 1, any wherein the preset switching condition comprises an existence the updated first material;
performing the switching operation on the at least one first material displayed on the material display page in response to the preset switching condition being satisfied comprises:
detecting whether a newly added first material and/or association information corresponding to the first material exist in a pre-stored material cache list in real time,
if the newly added first material and/or the association information corresponding to the first material exist, determining at least one first target material that satisfies a preset display condition according to an updated material cache list; and
performing the switching operation on the at least one first material displayed on the material display page according to the at least one first target material.

7. The method according to claim 1, wherein the material display page comprises at least one fixed display region and at least one display region that displays in turn, the fixed display region is used to fixedly display the first material that satisfies a preset display condition, and the display region that displays in turn is used to display the first material in a manner of displaying in turn;
performing the switching operation on the at least one first material displayed on the material display page in response to the preset switching condition being satisfied comprises:
performing the switching operation on the first material displayed in the at least one display region that displays in turn in response to the preset switching condition being satisfied.

8. The method according to claim 7, wherein the preset switching condition comprises the existence the updated first material;
performing the switching operation on the at least one first material displayed on the material display page in response to the preset switching condition being satisfied comprises:
detecting whether a newly added first material and/or association information corresponding to the first material exist in a pre-stored material cache list in real time;
determining a first updated material that satisfies a preset display condition according to an updated material cache list, and performing the switching operation on the first material currently displayed on the display region that displays in turn according to the first updated material;
for other first materials in the updated material cache list except for the first updated material that satisfies the preset display condition, determining a second display order corresponding to the other first materials according to association information corresponding to the other first materials; and
performing a switching operation of displaying in turn on the first material displayed on the at least one display region that displays in turn according to the second display order in response to the preset switching condition being satisfied.

9. The method according to claim 1, wherein the material display page comprises a first display region and a second display region, the first display region is used for displaying the first material, the second display region is used for displaying a second material, and the first material and the second material are different types of materials;
displaying the material display page in response to the acquisition operation of a user for the material display page comprises:
detecting whether the second display region comprises a second material that coincides with the first material displayed in the first display region, and
if the second display region comprises a second material that coincides with the first material displayed in the first display region, deleting the second material in the second display region that coincides with the first material displayed in the first display region.

10. The method according to claim 1, wherein the preset switching condition comprises the system time being matched with the preset switching time;
performing the switching operation on the at least one first material displayed on the material display page in response to the preset switching condition being satisfied comprises:
detecting whether the system time is matched with the preset switching time in real time, and
if the system time is matched with the preset switching time in real time, performing the switching operation on the at least one first material displayed on the material display page.

11. The method according to claim 1, wherein displaying the material display page in response to the acquisition operation of a user for the material display page comprises:
displaying the material display page in response to a triggering operation of the user on a preset target application; or,
displaying the material display page in response to an image editing instruction triggered by the user in an image editing application, wherein the material is used for an image editing operation.

12. (canceled)

13. An electronic device, wherein the device comprises: a processor and a memory;
the memory stores a computer execution instruction;
the processor executes the computer execution instruction stored in the memory, to cause the processor to execute a material display method, the material display method comprises:
displaying a material display page in response to an acquisition operation of a user for the material display page, wherein the material display page is used for displaying at least one first material; and
performing a switching operation on the at least one first material displayed on the material display page in response to a preset switching condition being satisfied,
wherein the preset switching condition comprises one or more items selected from a group consisting of system time being matched with preset switching time, an existence of an updated first material, a material update request triggered by the user being acquired, and a preset page jump operation triggered by the user being acquired.

14. A computer-readable storage medium, wherein the computer-readable storage medium stores a computer execution instruction, and upon the processor executing the computer execution instruction, a material display method is implemented, the material display method comprises:
displaying a material display page in response to an acquisition operation of a user for the material display page, wherein the material display page is used for displaying at least one first material; and
performing a switching operation on the at least one first material displayed on the material display page in response to a preset switching condition being satisfied,
wherein the preset switching condition comprises one or more items selected from a group consisting of system time being matched with preset switching time, an existence of an updated first material, a material update request triggered by the user being acquired, and a preset page jump operation triggered by the user being acquired.

15. (canceled)

16. (canceled)

17. The method according to claim 1, wherein performing the switching operation on the at least one first material displayed on the material display page in response to the preset switching condition being satisfied comprises:
performing the switching operation on the at least one first material displayed on the material display page in response to a page jump operation triggered by the user within the material display page that satisfies the preset switching condition.

18. The method according to claim 17, wherein the preset switching condition comprises a preset page jump operation triggered by the user being acquired;
if the page jump operation is matched with the preset page jump operation, it is determined that the preset switching condition is satisfied, and the switching operation is performed on the at least one first material displayed on the material display page.

19. The method according to claim 3, wherein the performance data comprises at least one selected from a group consisting of a total number of times the user has used the first material, the user's evaluation on the first material, a score of the first material.

20. The method according to claim 3, wherein the preset arrangement order is a descending order of the performance scores corresponding to the first materials or an ascending order of the performance scores corresponding to the first materials.

21. The method according to claim 1, wherein a page jump operation that satisfies the preset switching condition is pre-set;
performing the switching operation on the at least one first material displayed on the material display page in response to a preset switching condition being satisfied comprises:
performing the switching operation on the at least one first material displayed on the material display page in response to the page jump operation triggered by the user within the material display page that satisfies the preset switching condition, wherein
the page jump operation that satisfies the preset switching condition comprises at least one selected from a group consisting of re-entering the material display page, a saving edited content operation triggered on the material display page, a completing editing operation triggered on the material display page, and a restoring operation of a last edited image.

22. The method according to claim 5, wherein an operation triggered by the user on the material display page are obtained in real time, if the operation triggered by the user is matched with a preset operation, it is determined that the material update request triggered by the user is acquired;
the preset operation comprises any one selected from a group consisting of up sliding operation, down sliding operation, left sliding operation and right sliding operation, or the preset operation may also be a preset pattern drawn within a preset region, or,
the material display page is provided with an update control, the preset operation comprises triggering the update control by the user.

23. The method according to claim 2, wherein in response to the preset switching condition being satisfied, after performing the switching operation on the at least one first material displayed on the material display page according to the first display order, the method further comprises:
determining a first material that has not been displayed in the material cache list in response to a total number of a time of the switching operation reaches a preset switching times threshold; and
giving a priority to displaying the first material that has not been displayed on the material display page in response to the preset switching condition being satisfied again.
